(19) United States
(12) Patent Application Publication
(10) Pub. No.: US 2012/0056870 A1
(43) Pub. Date: Mar. 8, 2012

(54) TIMING CONTROLLER, COLUMN DRIVER AND DISPLAY APPARATUS COMPRISING SAME

(76) Inventor: Hwasu Koh, Kyunkgki-Do (KR)

(21) Appl. No.: 13/318,594

(22) PCT Filed: Apr. 12, 2010
(86) PCT No.: PCT/KR10/02239

§ 371 Date: Nov. 2, 2011

(30) Foreign Application Priority Data
May 13, 2009 (KR) 10-2009-0041773

(51) Int. Cl. G06F 3/038

(52) U.S. Cl. 345/215; 345/214

(57) ABSTRACT

The present invention relates to a timing controller, to a column driver, and to a display apparatus, comprising same. More particularly, the present invention relates to a timing controller, to a column driver, and to a display apparatus for providing a structure of a data signal transmission line and a signal transmission protocol which can achieve high signal quality and a low EMI level and which are highly efficient in effectively transmitting data.

### TECHNICAL FIELD

The present invention relates to a data bus structure for transmitting data of a display apparatus, a signal transmission protocol thereof and a display apparatus using the same, and more particularly relates to a timing controller, a column driver and a display apparatus including the same.

### BACKGROUND ART

Recently, a flat display apparatus that is thin and lightweight compared with conventional CRT has been widely used. Especially, display apparatuses such as an LCD, a PDP, an OLED, etc. have rapidly spread, replacing the CRT.

The flat display apparatus receives a data signal from an external host system and displays an image corresponding to the received data signal. Here, this display apparatus includes a panel driver for driving a panel.

The panel driver includes a timing controller, a scan driving section, a column driving section, etc. The data signal received from the external host system is inputted to the timing controller, and the timing controller reprocesses the input data signal and then provides the reprocessed data signal to the column driving section.

Recently, the size of the display apparatus has increased, and the resolution of the display apparatus has been augmented to display a high-definition image. In order to drive the display apparatus with high resolution, when data are transmitted between the timing controller and the column driver, it is required to transmit the data with higher signal quality and faster transmission speed than those of conventional techniques. Additionally, Low EMI level is required for reliability of the display apparatus system.

The display apparatus using RSDS (Reduced Swing Differential Signaling)/mini-LVDS (Low Voltage Differential Signaling) which is the conventional data signal transmission standard, uses a multi drop bus typed signal line structure. In the RSDS, as a transmission speed increases, a signal quality is rapidly reduced and EMI level increases due to impedance mismatch. In addition, since an effective transmission efficiency, which means the actual transmission of the data to the column driver for a certain signal speed, is very low, an effective transmission speed is not much increased in spite of the increased transmission speed. Point-to-Point Differential Signaling (PPDS) has been developed to resolve the above problem. The PPDS transmits a data signal through a signal line having a point-to-point structure in which impedance mismatch seldom occurs, and thus high signal quality can be maintained at a high transmission speed and EMI level can be also maintained within a satisfactory level. Clock signal transmission lines are connected by using a conventional multi-drop bus method in order to minimize the number of the required signal lines, thereby minimizing the area which the clock signal transmission line occupies in a panel. Due to the structural difference between the data signal transmission line and the clock signal transmission line, the arrival time of the signal arriving at the destination column driver is changed (clock-data skew; hereinafter referred to as “skew”), and the skew needs to be compensated in order to securely restore data in the column driver. The PPDS compensates for the skew by placing a preamble period within the data transmission protocol. Furthermore, the PPDS controls the column driver by using a data transmission interval which is placed within the data protocol to control the elements and operation of the column driver, and thus the column driver is effectively used.

The PPDS has a problem that the effective transmission efficiency is decreased because the preamble pattern and column driver control data as well as image data which are included in the data protocol are transmitted through every line. Accordingly, the PPDS should transmit data at a higher transmission rate than a method which transmits image data only. However, it is not easy to achieve the desired signal quality, EMI level and circuit design, etc.

### DISCLOSURE

### Technical Problem

The present invention provides a timing controller, a column driver, a display apparatus, a structure of a data signal transmission line and a signal transmission protocol which can achieve high effective data transmission efficiency as well as high signal quality and low EMI level when data are transmitted between the timing controller and the column driver in the display apparatus.

Particularly, the present invention provides a display apparatus, a column driver and a timing controller which can compensate for a skew of between a clock signal and a data signal which arrives at the column driver and provide high effective data transmission efficiency when transmitting data for controlling the elements and operation of the column driver.

### Technical Solution

In one aspect, the present invention provides a display apparatus comprising: a display panel for displaying an image; a timing controller for receiving a power supply voltage inputted from the outside, a data signal, a clock signal and a synchronization signal and outputting the data signal, the clock signal and the synchronization signal; and a column driver for applying a pixel data voltage to the display panel in accordance with the data signal serially received from the timing controller, wherein the timing controller transmits a setup information signal for setting up a registration and an operation of an element in the column driver during an initial setup mode before a normal driving mode in which a normal image is displayed after the power supply voltage is applied.

In another aspect, the present invention provides a display apparatus comprising: a display panel for displaying an image; a timing controller for receiving a power supply voltage inputted from the outside, a data signal, a clock signal and a synchronization signal and outputting the data signal, the clock signal and the synchronization signal; a column driver for receiving the data signal from the timing controller to apply an image signal to the display panel; a data signal transmission line for transmitting the data signal between the timing controller and the column driver; and a clock signal transmission line for transmitting the clock signal, wherein the column driver measures a skew between the data signal and the clock signal during an initial setup mode before a normal driving mode in which a normal image is displayed after the power supply voltage is applied, generates a skew compensation value by using the measured skew, and compensates for the skew between the data signal and the clock signal by using the generated skew compensation value.

In still another aspect, the present invention provides a display apparatus comprising: a display panel for displaying an image; a timing controller for receiving a power supply voltage inputted from the outside, a data signal, a clock signal and a synchronization signal and outputting the data signal, the clock signal and the synchronization signal; a column driver for receiving the data signal from the timing controller to apply an image signal to the display panel; a data signal transmission line disposed between the timing controller and the column driver to transmit the data signal; and a clock signal transmission line for transmitting the clock signal, wherein the column driver generates a skew compensation value by using a signal inputted during a vertical blanking interval or a horizontal blanking interval in a normal driving mode in which a normal image is displayed after the power supply voltage is applied, and compensates for the skew by applying the skew compensation value to the data signal or the clock signal.

In still another aspect, the present invention provides a display apparatus comprising: a display panel for displaying an image; a timing controller for receiving a power supply voltage inputted from the outside, a data signal, a clock signal and a synchronization signal and outputting the data signal, the clock signal and the synchronization signal; a column driver for applying a pixel data voltage to the display panel in accordance with the data signal serially received from the timing controller; a data signal transmission line for transmitting the data signal between the timing controller and the column driver; and a clock signal transmission line for transmitting the clock signal, wherein the timing controller transmits a setup information signal for setting up a registration and an operation of an element in the column driver during an initial setup mode before a normal driving mode in which a normal image is displayed after the power supply voltage is applied, and wherein the column driver receives the setup information signal, sets up the registration and the operation of the element of the column driver in the initial setup mode, measures a skew of between the data signal and the clock signal in the initial setup mode, generates a skew compensation value by using the measured skew, and compensates for the skew by using the generated skew compensation value.

In still another aspect, the present invention provides a display apparatus comprising: a display panel for displaying an image; a timing controller for receiving a power supply voltage inputted from the outside, a data signal, a clock signal and a synchronization signal and outputting the data signal, the clock signal and the synchronization signal; a column driver for applying a pixel data voltage to the display panel in accordance with the data signal serially received from the timing controller; a data signal transmission line for transmitting the data signal between the timing controller and the column driver; and a clock signal transmission line for transmitting the clock signal, wherein the timing controller transmits a setup information signal for setting up a registration and an operation of an element in the column driver during an initial setup mode before a normal driving mode in which a normal image is displayed after the power supply voltage is applied, and wherein the column driver receives the setup information signal, sets up the registration and the operation of the element of the column driver in the initial setup mode, measures a skew between the data signal and the clock signal during a horizontal blanking interval or a vertical blanking interval, generates a skew compensation value by using the measured skew, and compensates for the skew by using the generated skew compensation value.

In one aspect, the present invention provides a timing controller for transmitting a data signal to a column driver in a display apparatus, the timing controller comprising: a data format section for receiving a power supply voltage inputted from a host system, the data signal, a clock signal and a synchronization signal, and transmitting the data signal, the clock signal and the synchronization signal to the column driver; and a protocol controller for transmitting a setup information signal for setting up an element and an operation of the column driver during an initial setup mode before a normal driving mode in which a normal image is displayed after the power supply voltage is applied.

In another aspect, the present invention provides a timing controller for transmitting a data signal to a column driver in a display apparatus, the timing controller comprising: a data format section for receiving a power supply voltage inputted from a host system, the data signal, a clock signal and a synchronization signal, rearranging the data signal, and outputting the rearranged data signal; and a training pattern generating section for generating a training pattern signal to compensate for a skew generated between the clock signal and the data signal applied to the column driver during an initial setup mode before a normal driving mode in which a normal image is displayed after the power supply voltage is applied, wherein the training pattern signal is transmitted to the column driver through a data signal transmission line through which the data signal is transmitted.

In still another aspect, the present invention provides a timing controller for transmitting a data signal to a column driver in a display apparatus, the timing controller comprising: a data format section for receiving a power supply voltage inputted from a host system, the data signal, a clock signal and a synchronization signal, rearranging the data signal, and outputting the rearranged data signal; and a training pattern generating section for generating a training pattern signal to compensate for a skew generated between the clock signal and the data signal applied to the column driver in a horizontal blanking interval or a vertical blanking interval of a normal driving mode in which a normal image is displayed after the power supply voltage is applied.

In still another aspect, the present invention provides a timing controller for transmitting a data signal to a column driver in a display apparatus, the timing controller comprising: a data format section for receiving a power supply voltage inputted from a host system, the data signal, a clock signal and a synchronization signal, and transmitting the data signal, the clock signal and the synchronization signal to the column driver; a protocol controller for transmitting a setup information signal for setting up an element and an operation of the column driver during an initial setup mode before a normal driving mode in which a normal image is displayed after the power supply voltage is applied; and a training pattern generating section for generating a training pattern signal to compensate for a skew generated between the clock signal and the data signal applied to the column driver in the initial setup mode.

In still another aspect, the present invention provides a timing controller for transmitting a data signal to a column driver in a display apparatus, the timing controller comprising: a data format section for receiving a power supply voltage inputted from a host system, the data signal, a clock signal and a synchronization signal, and transmitting the data signal, the clock signal and the synchronization signal to the column driver; a protocol controller for transmitting a setup information signal for setting up an element and an operation of the column driver during an initial setup mode before a normal driving mode in which a normal image is displayed after the power supply voltage is applied; and a training pattern generating section for generating a training pattern signal in a vertical blanking interval or a horizontal blanking interval to compensate for a skew generated between the clock signal and the data signal applied to the column driver in the normal driving mode, wherein the training pattern signal is transmitted to the column driver through a data signal transmission line through which the data signal is transmitted.

In one aspect, the present invention provides a column driver for providing a pixel data voltage to a display panel in accordance with a data signal transmitted from a timing controller, wherein the column driver receives a setup information signal from the timing controller in an initial setup mode before a normal driving mode in which a normal image is displayed after the power supply voltage is applied or in the normal driving mode, transmits the setup information signal to at least one selected from the group consisting of an embedded data sampler, a serial-parallel converting section, a shift register, a data latch and a digital/analog converting section, and sets up its element and operation.

In another aspect, the present invention provides a column driver for providing a pixel data voltage to a display panel in accordance with a data signal transmitted from a timing controller, the column driver comprising: a skew compensating section for measuring a skew between a training pattern data signal and a clock signal received from the timing controller in a normal driving mode in which a normal image is displayed after a power supply voltage is applied or in an initial setup mode before the normal driving mode, and generate a skew compensation value corresponding to the measured skew, wherein the skew compensation value is applied to the data signal or the clock signal to compensate for the skew.

In still another aspect, the present invention provides a column driver for providing a pixel data voltage to a display panel in accordance with a data signal transmitted from a timing controller, the column driver comprising: a skew compensating section for measuring a skew between a training pattern data signal and a clock signal received from the timing controller in a normal driving mode in which a normal image is displayed after a power supply voltage is applied or in an initial setup mode before the normal driving mode, and generate a skew compensation value corresponding to the measured skew, wherein the skew compensation value is applied to the data signal or the clock signal to compensate for the skew, and wherein a setup information signal is received from the timing controller, and is transmitted to at least one selected from the group consisting of an embedded data sampler, a serial-parallel converting section, a shift register, a data latch and a digital/analog converting section, whereby setting up its element and operation.

### Advantageous Effects

A timing controller, a column driver and a display apparatus according to the present invention can minimize a skew between a clock signal and a data signal in the column driver, thereby enabling secure restoration of data in a high-resolution panel which requires high transmission speed.

The timing controller, the column driver and the display apparatus according to the present invention can have a highly effective transmission efficiency. Accordingly, since the display apparatus of the present invention needs lower transmission speed than a conventional display apparatus in case of displaying an image with the same resolution, it can achieve higher signal quality and lower EMI level.

Since the timing controller, the column driver and the display apparatus of the present invention can achieve higher signal quality and lower EMI level, the internal circuit of the timing controller and the column driver can be easily produced.

### DESCRIPTION OF DRAWINGS

FIG. 1 is a block diagram illustrating a display apparatus according to an embodiment of the present invention.

FIG. 2 is a block diagram illustrating a timing controller according to an embodiment of the present invention.

FIG. 3 is a block diagram illustrating a protocol controller of FIG. 2.

FIGS. 4 and 5 are waveform diagrams illustrating an example of the setup information signal outputted from the protocol controller of FIG. 2.

FIG. 5 is a waveform diagram illustrating a waveform of a training pattern signal transmitted from a training pattern generating section of FIG. 3.

FIG. 6 is a timing diagram illustrating an exemplary training pattern signal according to an embodiment of the present invention.

FIGS. 7a to 7c are waveform diagrams illustrating the waveforms of the setup information signal for setting up the column driver during the initial setup mode and the signals outputted from the timing controller for compensating for the skew of the column driver by using the training pattern.

FIG. 8 is a waveform diagram illustrating that the training pattern signal is transmitted in a horizontal blanking interval.

FIG. 9 is a waveform diagram illustrating that the training pattern signal is transmitted in a vertical blanking interval.

FIG. 10 is a block diagram illustrating the column driver of FIG. 1.

FIG. 11 is a block diagram illustrating an embodiment of a skew-calculating section of FIG. 10.

FIG. 12 is a waveform diagram illustrating that a late/early value provided from a phase-measuring section of FIG. 11 to a FSM is determined.

FIG. 13 is a waveform diagram illustrating the operation of the phase-measuring section for detecting the skew by using the data of the normal driving mode when the compensation of the skew of the normal driving mode is required after performing the compensation of the skew by using the phase-measuring section of FIG. 11 in the initial setup mode.

FIGS. 14 to 16 are waveform diagrams illustrating the operation of the phase-measuring section operated in the normal driving mode of FIG. 11.

| | |
|---|---|
| 100: display panel | 200: panel driving section |
| 300: backlight module | 400: power supply section |
| 500: timing controller | |
| 600: scan driving section | 700: column driving section |
| 701~704: first to nth column driver | |

### BEST MODE

The present invention may have various modifications and embodiments, and the specification will describe specific embodiments illustrated in the drawings in detail hereinafter. It should be understood, however, that there is no intent to limit the present invention to the specific embodiments, and the present invention covers all modifications, equivalents, and alternatives falling within its spirit and scope. If the detailed description about the relevant publicly-known arts in the present invention is regarded as obscuring the gist of the present invention, it will be omitted.

It will be understood that when the terms “first,” “second,” etc. are used to explain a plurality of elements, these terms are not intended to limit the elements but distinguish one element from other elements.

The terminology used herein is for the purpose of describing specific embodiments only and is not intended to limit the present invention. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, integers, steps, operations, elements and/or components, but do not preclude the presence or addition of one or more other features, integers, steps, operations, elements, components and/or groups thereof.

Hereinafter, the embodiments of the present invention will be described in detail with reference to accompanying drawings. In the drawings, like reference numerals identify similar or identical elements.

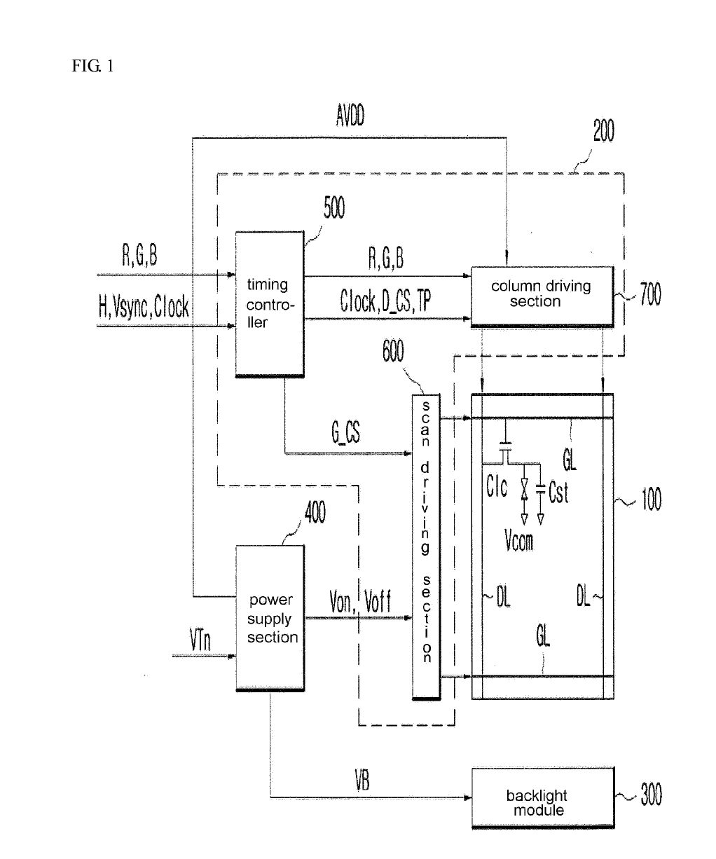

Before giving the description related to drawings, it should be understood that elements in the specification are just discriminated in accordance with their main function. In other words, two or more elements may be added as one element or one element may be divided into two elements in accordance with a subdivided function. Additionally, each of the elements in the following description may perform a part or whole of the function of another element as well as its main function, and some of the main functions of each of the elements may be performed exclusively by other elements. Accordingly, existence of the elements in the description of the present invention may be interpreted in accordance with function, and so constitution of the elements in a display apparatus of the present invention may be different from that in FIG. 1 as long as it achieves the object of the present invention.

FIG. 1 is a block diagram illustrating a display apparatus according to an embodiment of the present invention.

In FIG. 1, the display apparatus of the present invention includes a display panel 100, a backlight module 300, a power supply section 400 and a panel driver 200.

The display panel 100 is one of the display panels such as a liquid crystal display panel, plasma display panel, OLED panel, etc. Hereinafter, the display panel 100 will be explained as the liquid crystal display panel.

The liquid crystal display panel may include liquid crystal, a thin film transistor substrate and a color filter substrate.

The liquid crystal display panel includes a plurality of thin transistors, and a pixel data voltage is provided by driving the thin transistors. In the liquid crystal display panel, the liquid crystals are driven by an electric field generated between the thin film transistor substrate and the color filter substrate due to the pixel data voltage, whereby an image is displayed.

The backlight module 300 provides light to the display panel 100 and may include at least one lamp or a plurality of light emitting diodes for providing the light.

The power supply section 400 generates an analog driving voltage (AVDD), a gate on voltage (VON) and a gate off voltage (VOFF) by using an input voltage. The analog driving voltage (AVDD) is provided to a column driving section 700, and the gate on voltage (VON) and the gate off voltage (VOFF) are provided to a scan driving section 600.

In addition, the power supply section 400 may provide a backlight driving voltage (VB) which drives the backlight module 300.

The scan driving section 600 provides the gate on/off voltage (VON/VOFF) to gate lines (GL) of the display panel 100.

The column driving section 700 may include a plurality of column drivers 701 to 704. The column driving section 700 provides the pixel data voltage to the display panel 100. Here, each of the column drivers 701 to 704 is connected to a plurality of data lines (DL).

After the column driving section 700 receives data, clock and other signals, which are required for displaying an image, from the timing controller 500 and restores the data, it provides the pixel data voltage to the display panel 100.

The timing controller 500 receives a data signal, a clock signal, a synchronization signal, etc. which are inputted from a host system, sets pixel display data and timing control signals needed for the pixel display data in accordance with an image to be displayed on the display panel 100, and provides the pixel display data and the timing control signals to the scan driving section 600 and the column driving section 700. Furthermore, the timing controller 500 transmits a setup information signal for registering the elements of each column driver of the column driving section 700 and setting the operation of the column drivers.

The timing controller 500 generates a training pattern signal and provides it to the column driving section 700 to compensate for the skew between the clock signal and the data signal.

In the display apparatus according to an embodiment of the present invention, each of the column drivers 701 to 704 of the column driving section 700 and the timing controller 500 are connected to a data signal transmission line to be a point-to-point structure, and are connected to a clock signal transmission line by using a multi-drop method. Moreover, the display apparatus may include a TMC signal transmission line for transmitting a TMC signal, and the TMC signal transmission line is connected to each of the column drivers 701 to 704 by using the multi-drop method.

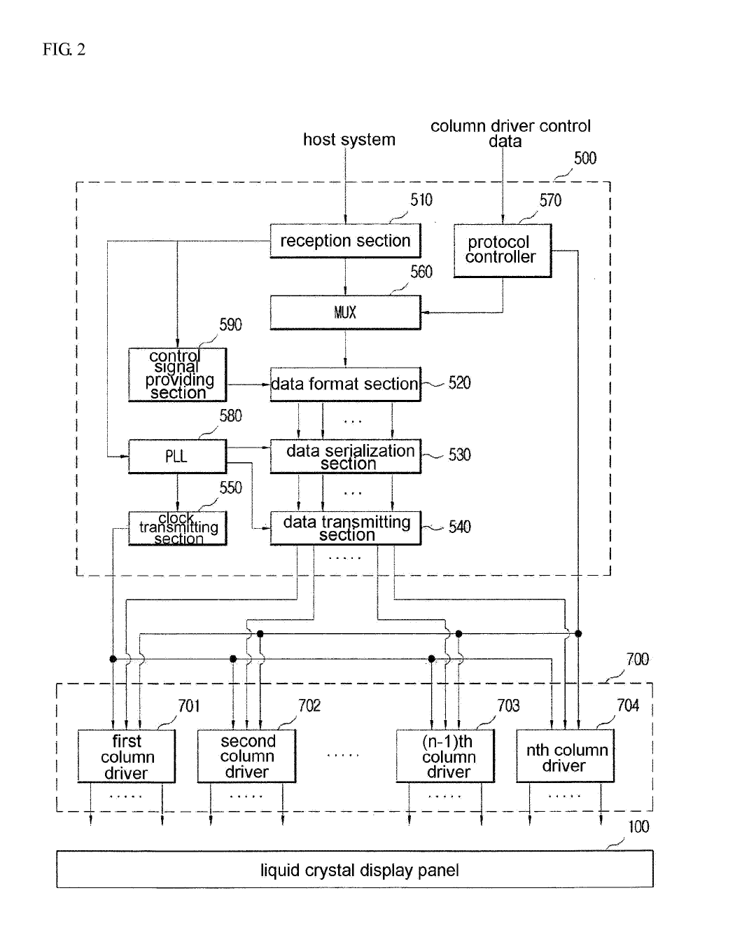

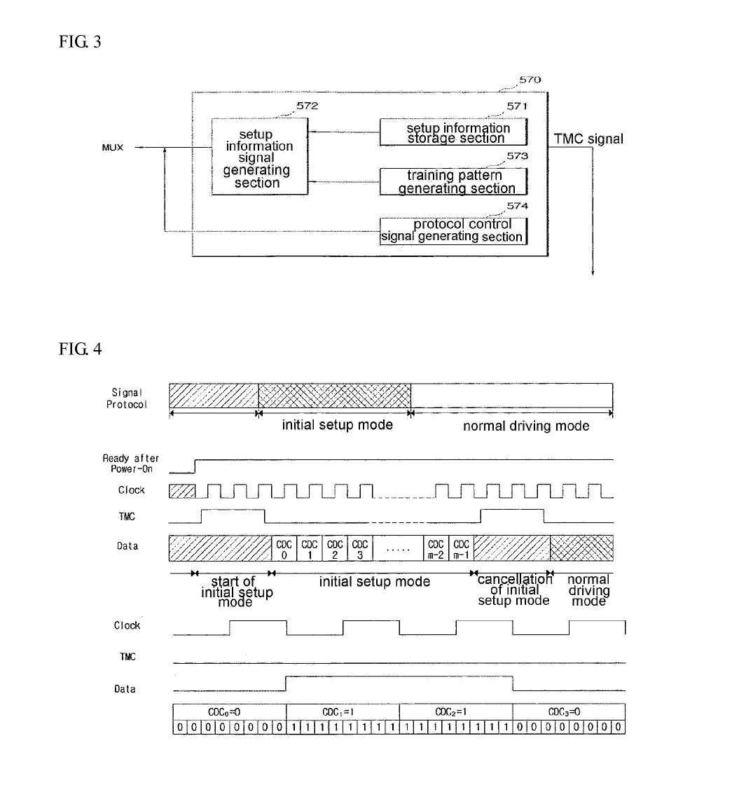

FIG. 2 is a block diagram illustrating a timing controller according to an embodiment of the present invention. FIG. 3 is a block diagram illustrating a protocol controller of FIG. 2.

In FIGS. 2 and 3, the timing controller 500 includes a reception section 510, a multiplexer (MUX) 560, a timing control signal providing section 590, a PLL 580, a data serialization section 530, a data format section 520, a clock transmitting section 550, data transmitting section 540 and a protocol controller 570. Here, the protocol controller 570 may have a setup information signal generating section 572, a setup information storage section 571 and a training pattern generating section 573. The training pattern generating section 573 may be included in the protocol controller 570. For the sake of convenience, the training pattern generating section 573 is described as being included in the protocol controller 570, but it may exist separately from the protocol controller 570.

The reception section 510 transmits the data signal (R, G, B), the vertical/horizontal synchronization signal (Vsync/Hsync) and the clock signal (Clock), etc., which are inputted from the external host system, to the data format section 520, the PLL 580 and the timing control signal providing section 590. The reception section 510 transmits the data signal (R, G, B) to the data format section 520 through the multiplexer 560. The reception section 510 transmits the vertical/horizontal synchronization signal (Vsync/Hsync) to the timing control signal providing section 590 and transmits the clock signal (Clock) to the PLL 580.

The timing control signal providing section 590 controls the operation of the data format section 520 in accordance with the inputted synchronization signals (Vsync and Hsync).

The PLL 580 receives the inputted clock signal and transmits the clocks of the required frequency to the data format section 520, the data serialization section 530 and the clock transmitting section 550. Here, the PLL 580 locks the phase of the clock signal, thereby outputting the clock signal in a constant period.

The data format section 520 converts the format of the data signal (R, G, B) which is inputted at the multiplexer 560 to correspond to the data channel format and the data signal protocol and then transmits it to the data serialization section 530.

The data serialization section 530 serializes the parallel data which is transmitted from the data format section 520 and then transmits it to the column driver 701 through the data transmitting section 540.

Here, the data transmitting section 540 is connected to each of the column drivers 701 to 704 by using the point-to-point method. That is, the data transmitting section 540 is connected to each of the column drivers 701 to 704 through the data signal transmission line. Here, the data signal transmission line may transmit signals in a single-ended signaling manner which uses one wire or in a differential signaling manner which uses two wires and show a signal as the voltage difference between the two wires.

The clock transmitting section 550 transmits the inputted clock signal (Clock) to the column driving section 700. The clock transmitting section 550 may transmit the clock signal (Clock), which is converted in accordance with the signal protocol, to the column driving section 700.

As shown in FIG. 2, the clock transmitting section 550 is connected to the column drivers 701 to 704 through the clock signal transmission line. Here, the clock signal transmission line has a multi-drop bus structure.

In addition, the clock signal transmission line may connect the clock transmitting section 550 to the column drivers 701 to 704 by using a daisy chain method, in which the first column driver and the column drivers which are disposed between the first column driver and the final column driver are serially connected on the basis of priority order.

The protocol controller 570 receives a column driver control (hereinafter, referred to as “CDC”) data signal, generates a setup information signal and transmits it to the multiplexer 560.

The protocol controller 570 generates a transfer mode control (hereinafter, referred to as “TMC”) signal for verifying whether or not the setup information signal and the training pattern signal are transmitted, and transmits it to the column drivers 701 to 704.

As shown in FIG. 3, the protocol controller 570 may include a setup information signal generating section 572, a setup information storage section 571, a training pattern generating section 573 and a protocol control signal generating section 574.

The setup information storage section 571 is activated so as to transmit the setup information signal in case power is supplied to the protocol controller 570, and transmits the stored signal to the setup information signal generating section 572 so that the setup information signal generating section 572 generates the setup information signal. The setup information signal generating section 572 transmits the setup information signal, which is transmitted from the setup information storage section 571, to the data format section 520 through the multiplexer 560.

The training pattern generating section 573 generates a training pattern signal, which will be described later. In FIG. 3, the training pattern generating section 573 is illustrated as being included in the protocol controller 570. However, the training pattern generating section 573 is not limited to the embodiment in FIG. 3 and may exist outside the protocol controller 570.

The protocol controller 570 controls the multiplexer 560 by using the signal generated by the protocol control signal generating section 574 to select data from one of the reception section 510 and the protocol controller 570 and transmit the selected data to the data format section 520.

The protocol controller 570 generates a protocol control signal and controls the multiplexer 560 by using the generated protocol control signal to select data from one of the reception section 510 and the protocol controller 570 and transmit the selected data to the data format section 520.

The protocol control signal generating section 574 for generating the protocol control signal and controlling the multiplexer 560 may be included in the protocol controller 570 as shown in FIG. 2, or may exist outside of the protocol controller 570.

The setup information signal may include the information of the number of active pixels in the liquid crystal display panel 100, delay information, inversion mode information, line polarity information, scramble information, gate delay information, vertical blanking interval information, data polar information and aging/refresh operation mode information, etc.

The information of the number of the active pixels includes the information on the number of the pixels which are actually used among the total pixels corresponding to each of the column drivers.

The delay information includes the information concerning the delay time that is defined as the time which is delayed until the corresponding column driver actually operates after receiving a data load signal in order to minimize the fluctuation of the power supply voltage which happens when all of the column drivers operate simultaneously.

The inversion mode information includes the information of the polarity inversion method such as line inversion, dot inversion, two-dot inversion, frame inversion, etc.

The line polarity information includes the information for indicating the polarity of the first line.

The scramble information includes the information on whether data is transmitted without being scrambled or is transmitted after being scrambled.

The gate delay information includes the information for indicating the signal delay time of between the corresponding column driver and a gate line, and the delay of the gate line may be programmed.

Delta delay information includes the information on the delay time at the column pixel of the corresponding column driver. The delta delay information may include the information on the delay time, which is required to drive the column in accordance with the delay time of the corresponding column pixel, along with the gate delay information.

The vertical blanking interval information includes the information for indicating whether or not the current operation is in a vertical blanking mode, and the signal information which is periodically provided during the operation even after the power supply voltage is applied.

The data polarity information includes the information for showing the inversion polarity of the corresponding line.

The aging/refresh operation mode information includes the information on whether the column driver operates in a normal mode or in an aging or refresh operation mode.

For example, the setup information signal may be a binary data signal having a specific value. In other words, the setup information signal may be transmitted as a binary data signal sequence like the data signal.

The setup information signal may include a first setup information signal transmitted in an initial setup mode and a second setup information signal transmitted in a normal driving mode. Here, the first setup information signal may be the information of the number of the active pixels among total pixels, the driving delay information, the inversion mode information, the initial signal polarity information, the scramble information, the gate delay information, the delta delay information, etc. The second setup information signal may be the vertical blanking interval information, the data polarity information, the aging/refresh operation mode information, etc.

FIGS. 4 and 5 are waveform diagrams illustrating an example of the setup information signal outputted from the protocol controller of FIG. 2.

As shown in FIG. 4, the operation mode of the signal protocol of the timing controller consists of a power input initial mode which is an initial state after the power supply voltage is applied, an initial setup mode which is in a certain time after the power supply voltage is applied, and a normal driving mode which transmits an effective data signal.

Here, the timing controller operates in the initial setup mode if the protocol signal which indicates the entry into the initial setup mode is inputted (when TMC maintains “High” logic at the rising time of three consecutive clocks). In the initial setup mode, the setup information signal is inputted. As shown in FIG. 4, binary data sequence such as “CDC0=0,” “CDC1=1,” “CDC2=1,” “CDC3=0,” etc. is inputted as the setup information signal (CDC means a Column Driver Control data signal). The transmission speed of the CDC is set up to be lower than that of the normal data to secure stable data restoration. That is, the setup information mode transmits one identical data repeatedly during one clock period, whereas the normal driving mode transmits the data which correspond to one pixel data (sub-pixel data) during one clock period. After all of the setup information signal are transmitted, the protocol signal for indicating that the initial setup mode is finished is transmitted (when TMC maintains “High” logic at the rising time of three consecutive clocks), whereby the initial setup mode is finished. After the initial setup mode is finished, the timing controller operates in the normal driving mode and transmits the effective data signal to the column driver.

As shown in FIG. 5, if the protocol signal for indicating the entry into the initial setup mode is inputted (when TMC maintains “High” logic at the rising time of three consecutive clocks), the initial setup mode starts. If the initial setup mode starts, the setup information signal is inputted. After all of the setup information signal are transmitted, the protocol signal for indicating that the initial setup mode is finished is transmitted (when TMC maintains “High” logic at the rising time of two consecutive clocks), whereby the initial setup mode is finished. After the initial setup mode is finished, the timing controller operates in the normal driving mode and transmits the effective data signal to the column driver.

In the present invention, the setup information signal may be transmitted to the column driver in a horizontal blanking interval and a vertical blanking interval.

As shown in FIGS. 4 and 5, the present invention may transmit a training pattern during the initial setup mode instead of transmitting a setup information of the column driver, and compensate for the skew generated due to the difference between the transmission speed of the data and the transmission speed of the clock signal by using the training pattern.

The training pattern generating section 573 transmits a training pattern signal to the data format section 520. The training pattern generating section 573 is connected to the data transmitting section 540 and transmits the training pattern signal during the interval in which the effective data signal is not provided. When the display apparatus initially operates, the training pattern generating section 573 may transmit the training pattern signal during one of the interval in which the effective data signal is not applied yet, the horizontal blanking interval and the vertical blanking interval.

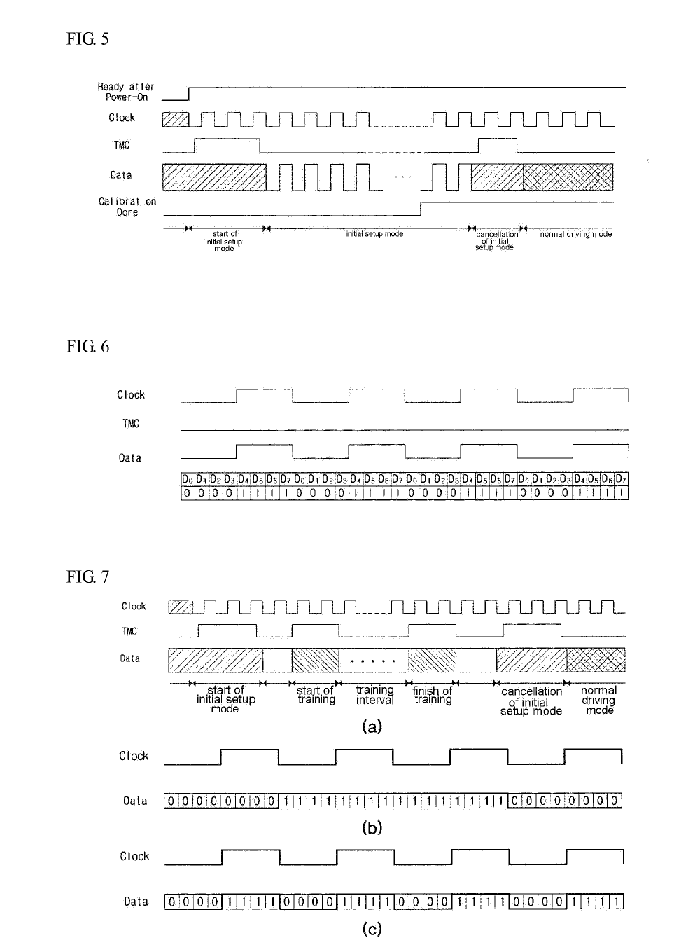

The above description will be explained in detail with reference to FIGS. 6 to 7c.

FIG. 6 is a timing diagram illustrating an exemplary training pattern signal according to an embodiment of the present invention.

FIG. 6 is a waveform diagram illustrating an embodiment of the training pattern which is transmitted from the training pattern generating section of FIG. 3. The training pattern signal is transmitted with a constant period and may have the same pulse width as a clock signal. Here, the training pattern may be synchronized with the clock signal which the timing controller receives and be transmitted. The training pattern in which the same signal as the clock signal is stored in advance may be transmitted.

In addition, the training pattern signal may have the same rising part as that of the clock signal or have the same falling part as that of the clock signal.

Here, the training pattern signal may be transmitted in the initial setup interval, and be also transmitted in the horizontal blanking interval and the vertical blanking interval of the normal driving mode.

FIG. 6 shows the training pattern signal having the same pattern as the clock signal. However, the training pattern signal is not limited to the pattern illustrated in FIG. 6 and may be a signal having a constant period.

FIGS. 7a to 7c are waveform diagrams illustrating the waveforms of the setup information signal for setting up the column driver during the initial setup mode and the signals outputted from the timing controller for compensating for the skew of the column driver by using the training pattern.

As shown in FIG. 7a, the timing controller operates in the initial setup mode if the protocol signal which indicates the entry into the initial setup mode is inputted (when TMC maintains “High” logic at the rising time of three consecutive clocks). In this case, the data of the setup information signal shown in FIG. 7b is outputted.

Subsequently, if the protocol signal for indicating the entry into the training mode is inputted (when TMC maintains “High” logic at the rising time of two consecutive clocks), the training pattern signal shown in FIG. 7c is inputted. Then, after all of the training pattern signals are transmitted, the protocol signal for indicating that the training mode is finished is transmitted (when TMC maintains “High” logic at the rising time of two consecutive clocks), whereby the training mode is finished. Then, the protocol signal for indicating that the initial setup mode is finished is transmitted (when TMC maintains “High” logic at the rising time of three consecutive clocks), whereby the initial setup mode is finished. After the initial setup mode is finished, the normal driving mode operates, and the effective data signal is transmitted to the column driver.

### MODE FOR INVENTION

Hereinafter, another embodiment of the present invention will be described.

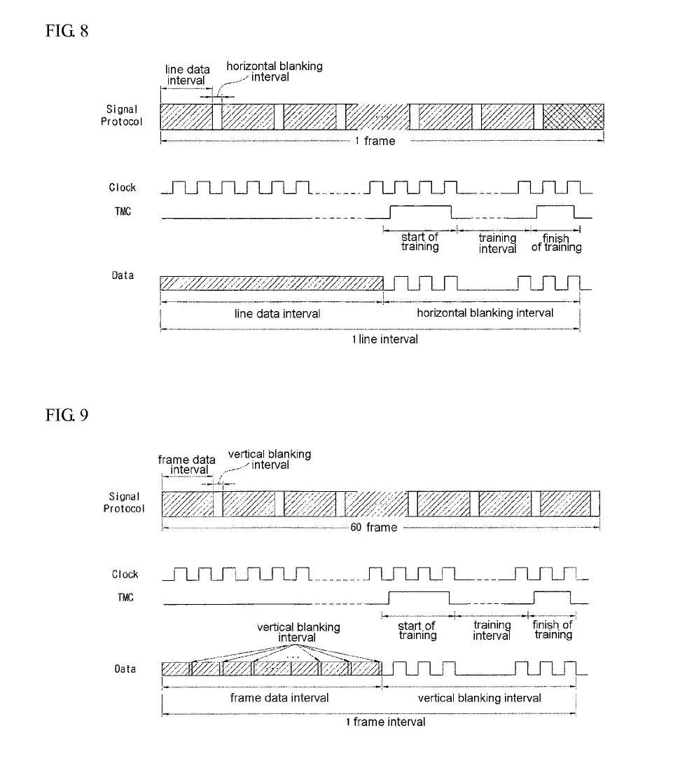

FIG. 8 is a waveform diagram illustrating that the training pattern signal is transmitted in a horizontal blanking interval. FIG. 9 is a waveform diagram illustrating that the training pattern signal is transmitted in a vertical blanking interval.

As shown in FIG. 8, the timing controller 500 transmits a plurality of line data during one frame. Here, the horizontal blanking interval exists between all of the line data intervals. The training pattern signal is transmitted to the column driver in the horizontal blanking interval. Therefore, the column driver periodically generates a skew compensation value, stores it and applies it to the data signal which is inputted in the next line data interval.

As shown in FIG. 9, in case sixty frames of data is transmitted, the vertical blanking interval exists between all of the frame data transmission intervals. Here, the timing controller 500 transmits the training pattern signal to the column driver in the vertical blanking interval. The column driver generates the skew compensation value by using the training pattern signal which is transmitted in the vertical blanking interval, and stores the generated skew compensation value. Then, if the next frame data is inputted, the column driver applies the stored skew compensation value to the next frame data, thereby compensating for the data signal and the clock signal and outputting the compensated data signal and clock signal.

The data transmitting section 540 of the timing controller 500 is connected to the column drivers 701 to 704 to be a point-to-point structure, thereby enabling to enhance the signal quality and the effective transmission rate for the transmission speed. As shown in FIG. 2, the clock transmitting section 550 is connected to the column drivers 701 to 704 to be a multi-drop bus structure. Accordingly, since the clock signal and the data signal which arrive at the same column driver have different propagation time due to the different connection structure (a skew occurs), it is difficult to securely restore the data due to the timing error between the clock signal and the data signal for restoring the data. It is more difficult to securely restore the data if the data transmission frequency increases.

In order to prevent the above data-restoring errors, the present invention generates the skew compensation value by using the training pattern. In addition, the present invention applies the skew compensation value to the data signal or the clock signal, thereby synchronizing the timings of the data signal and the clock signal. That is, as shown in FIG. 3, the training pattern generating section 573 may provide the training pattern signal which is synchronized with the clock signal.

The clock signal is transmitted to the column driving section 700 through the clock transmitting section 550, and the training pattern signal is transmitted to the column driving section 700 through the data transmitting section 540. The column driving section 700 compares the clock signal which is inputted at the clock transmitting section 550 with the data signal which is inputted at the data transmitting section 540, and compensates for the data signal or the clock signal.

In one embodiment of the present invention, the training pattern signal is transmitted in one of the initial setup mode and the normal driving mode. The skew compensation value is calculated by using the training pattern signal as described above, and the data signal or the clock signal is compensated by applying the skew compensation value to the data signal or the clock signal.

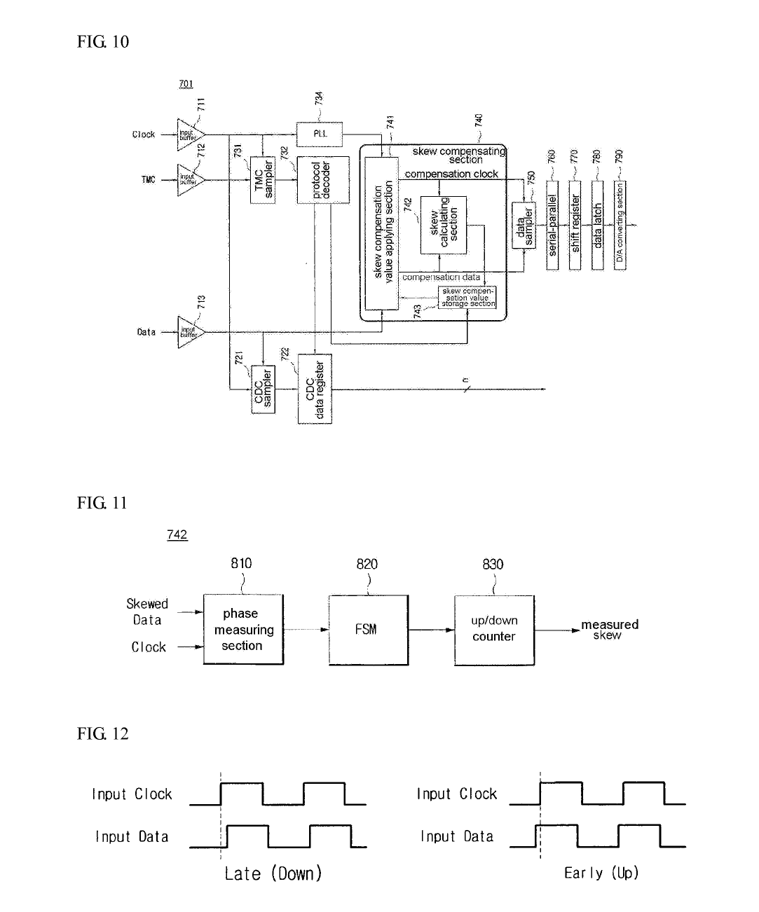

FIG. 10 is a block diagram illustrating the column driver of FIG. 1.

Referring to FIG. 10, the column driver 701 according to the present invention may include a plurality of input buffers 711 to 713, a TMC sampler 731, a CDC sampler 721, a CDC data register 722, a protocol decoder 732, a PLL 734, a skew compensating section 740, a serial-parallel converting section 760, a shift register 770, a data latch 780 and digital/analog converting section 790. Here, the skew compensating section 740 may include a skew compensation value applying section 741, a skew-calculating section 742 and a skew compensation value storage section 743.

Particularly, the input buffers 711 to 713 converts the received external signals into the internal signals, and then transmits the internal signals to the next element. Input buffers 711 to 713 may include the input buffer 711 for receiving the clock signal, the input buffer 713 for receiving the data signal, and the input buffer 712 for receiving the control signal.

The PLL 734, which is a phase-locking loop, receives the clock input and the buffer output, generates the clocks which are multiplied with the desired frequency, and locks the phase of the clock signal. A clock signal outputted from the PLL 734 is inputted to the skew compensating section 740 as a clock signal source. The skew compensating section changes the phase of the clock signal or the phase of the data signal, thereby transmitting the clock signal and the data signal, the skews of which are compensated, to the data sampler 750. The data sampler 750 samples the inputted serial data signal to discriminate “1” or “0” and transmit it to the serial-parallel converting section 760.

The serial-parallel converting section 760 converts the data signal of the serial signal which is discriminated by the data sampler 750 into a parallel signal, and then transmits it to the shift register 770.

The shift register 770 shifts the data start pulse, which is transmitted from the timing controller 500, in sequence in accordance with a data shift clock, thereby generating a sampling signal.

The data latch 780 latches the data signals of R, G and B in sequence in response to the sampling signal which is generated by the shift register 770 and the load signal which is applied from the timing controller 500. When the data in a horizontal line are latched, the data latch 780 simultaneously transmits them to the digital/analog converting section 790.

The digital/analog converting section 790 outputs an analog data voltage by using the analog supply voltage (AVDD) which is supplied from the power supply section 400. In other words, the digital/analog converting section 790 selects the voltage which corresponds to the data signal supplied from the data latch 780 among the analog supply voltages (AVDD), and outputs the selected analog data voltage.

Here, the column driving section 700 may further include a gamma voltage generating section for converting the analog voltage (AVDD) into a plurality of gamma voltages. The gamma voltage generating section divides the analog voltage, which is inputted at a resistor array, into the voltage levels, which correspond to each resistance value, and outputs them. The outputted gamma voltage is transmitted to the digital/analog converting section 790.

The TMC sampler 731 receives the TMC signal which is inputted to the TMC input buffer, samples the TMC signal in accordance with the clock signal, and then transmits it to the protocol decoder 732.

The protocol decoder 732 decodes the transmitted TMC signal and transmits the control signal which activates the CDC data register 722 or the skew compensation value storage section 743. For example, the protocol decoder 732 transmits the enable signal which activates the skew compensation value storage section 743 if the signal which is transmitted from the TMC sampler 731 is a transmission mode control signal (TMC). The protocol decoder 732 transmits the enable signal which activates the CDC data register 722 if the signal which is transmitted from the TMC sampler 731 is a column driver control controlling signal (CDCC).

The CDC data sampler receives the CDC signal and transmits it to the CDC data register 722. Here, the CDC data sampler 721 samples the inputted CDC signal and transmits it to the CDC data register 722.

The CDC data register 722 stores the CDC data signal which is transmitted from the CDC sampler 721 for a certain time, and then transmits it to each element of the column driver 701.

For example, the CDC data register 722 applies the information of the number of the active pixels to the shift register 770, thereby activating the number of the operating pixels of the liquid crystal display panel to set up its operation.

The CDC data register 722 transmits the gate delay information to the digital/analog converting section, thereby setting up the actual driving time in case of gate delay.

The CDC data register 722 transmits the inversion mode information, the line polarity information, the scramble information, the delta delay information, the delay information, the vertical blanking interval information, the data polarity information, the aging/refresh operation mode information, etc. to the corresponding elements of the serial-parallel converting section 760, the shift register 770, the data latch 780 and the digital/analog converting section 790, thereby setting up the column driver.

The skew compensating section 740 may calculate a skew value, stores the calculated skew value and compensate for the data signal or the clock signal by using the stored skew value. In order to compensate for the data signal or the clock signal, the skew compensating section 740 may include the skew compensation value applying section 741, the skew-calculating section 742 and the skew compensation value storage section 743.

The skew compensation value applying section 741 compensates for the clock signal which is transmitted from the PLL 734 and the data signal which is transmitted from the timing controller 500 by applying the skew compensation value provided form the skew compensation value storage section 743 to the clock signal and the data signal. For example, the skew compensation value applying section 741 compensates for the data signal and the clock signal by applying the skew compensation value to the data signal and the clock signal in the normal driving mode, and then outputs the compensated data signal and the compensated clock signal.

The skew compensation value storage section 743 stores the skew compensation value obtained through the skew value calculated by the skew-calculating section 742, and provides the stored skew compensation value to the skew compensation value applying section 741 in the normal driving mode. Here, the skew compensation value storage section 743 transmits the skew compensation value to the skew compensation value applying section 741 in case the enable signal is applied from the protocol decoder 732.

The skew compensation value storage section 743 may be a memory in which the skew compensation value transmitted from the skew-calculating section 742 is stored in the form of a binary signal or a capacitor in which the skew compensation value is stored in the form of a voltage.

The skew-calculating section 742 may calculate the skew value by using the inputted training pattern signal and the clock signal, and generate the skew compensation value. For example, the skew-calculating section 742 generates the skew compensation value by using the phase difference of between the training pattern signal and the clock signal. The skew-calculating section 742 determines the skew compensation value as zero (0) in case the phase of the training pattern signal and phase of the clock signal are the same (e.g., the rising time of pulses in the training pattern signal and the rising time of pulses in the clock signal are the same), and determines the skew compensation value as the value corresponding to the phase difference in case the phase of the training pattern signal and the phase of the clock signal are different.

The skew-calculating section 742 will be described in detail with reference to FIGS. 11 to 16.

FIG. 11 is a block diagram illustrating an embodiment of a skew-calculating section of FIG. 10. FIG. 12 is a waveform diagram illustrating that a late/early value provided from a phase-measuring section of FIG. 11 to a FSM is determined.

As shown in FIG. 11, the skew-calculating section 742 may include a phase-measuring section 810, a finite state machine (hereinafter, referred to as “FSM”) 820 and an up/down counter 830.

Particularly, the phase-measuring section 810 compares the phase of the inputted training pattern signal with the phase of the inputted clock signal. The phase-measuring section 810 transmits the comparison value obtained from the phase-comparison between the training pattern signal and the clock signal to the FSM 820.

As shown in FIG. 12, the phase-measuring section 810 transmits an early value to the FSM 820 in case the training pattern signal is later than the clock signal, and transmits a late value to the FSM 820 in case the training pattern signal is earlier than the clock signal.

The FSM 820 properly processes the signal outputted from the phase-measuring section 810, transmits an up signal to the up/down counter 830 in case the phase should be earlier, and transmits a down signal to the up/down counter 830 in case the phase should be later. That is, the FSM 820 receives the early/late output signal from the phase-measuring section 810, processes accumulatively the early/late signals during a certain time, transmits the up signal to the up/down counter 830 in case the phase should be earlier, and transmits the down signal to the up/down counter 830 in case the phase should be later.

The up/down counter 830 counts the signal transmitted from the FSM 820, thereby measuring the skew. The up/down counter 830 calculates the skew compensation value by using the counted skew, and transmits the calculated skew compensation value to the skew compensation value storage section 743.

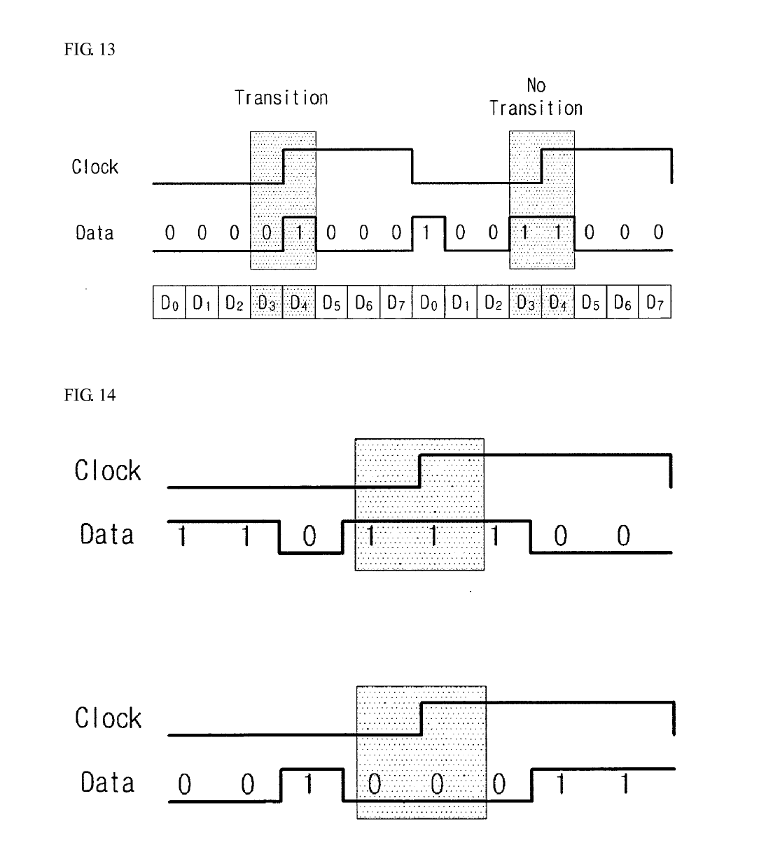

FIG. 13 is a waveform diagram illustrating the operation of the phase-measuring section for detecting the skew by using the data of the normal driving mode when the compensation of the skew of the normal driving mode is required after performing the compensation of the skew by using the phase-measuring section of FIG. 11 in the initial setup mode.

As shown in FIG. 13, the phase-measuring section 810 of the skew-calculating section 742 compares the phases only when data is transited (0=>1 or 1=>0) at the data D3 and D4 near the edge of the clock signal, and outputs the early or late result. The phase-measuring section 810 does not output the phase-comparing result in case the data is not transited.

FIGS. 14 to 16 are waveform diagrams illustrating the operation of the phase-measuring section operated in the normal driving mode of FIG. 11.

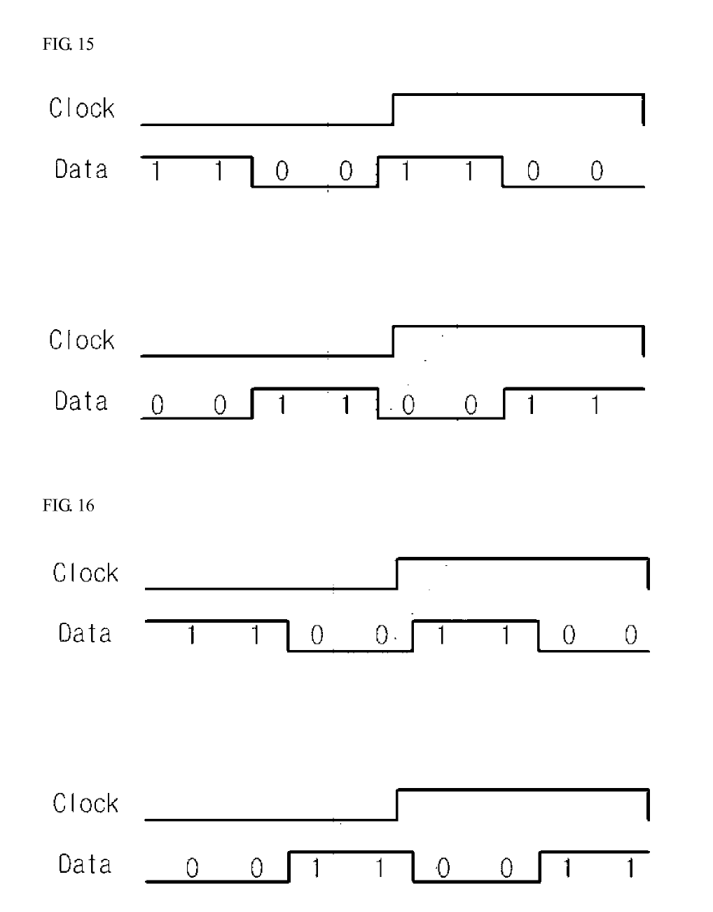

As shown in FIG. 14, since the data is not transited between D3 and D4, the output of the phase-measuring section is “Early=Late=0.” As shown in FIG. 15, since the data transition of between D3 and D4 is earlier than the edge of the clock, the output of the phase-measuring section is “Early=1, Late=0.” As shown in FIG. 16, since the data transition of between D3 and D4 is later than the edge of the clock, the output of the phase-measuring section is “Early=0, Late=1.” The skew between the clock signal and the data signal is compensated by using the output of the phase-measuring section in the normal driving mode, and the other elements of the skew compensating section 740 may be used in common. For example, the skew will not be detected in case the edge of the clock signal and the edge of second bit signal of the training pattern signal are the same. That is, the skew value will not be detected in case the start part of arbitrary bit signal is the same as the edge of the clock signal although the rising or falling of the arbitrary bit signal does not happen at the rising part of the clock signal.

The display apparatus of the present invention separately illustrates the timing controller and the column driver, but the timing controller and the column driver may exist together, which would be well known to a skilled artisan.

Although the present invention has been described with reference to a number of illustrative embodiments thereof, it should be understood that numerous other modifications and variations could be devised by a skilled artisan that will fall within the spirit and scope of the principles of this disclosure.

### INDUSTRIAL APPLICABILITY

As explained above, the display apparatus, the timing controller and the column driver according to the present invention can easily set up the constitution and operation of the column driver and also have a high data transmission efficiency.

The display apparatus, the timing controller and the column driver according to the present invention can securely restore data with a high speed and also have a high data transmission efficiency when transmitting the serialized data signal between the timing controller and the column driver

1. A display apparatus comprising:
a display panel for displaying an image;
a timing controller for receiving a power supply voltage inputted from the outside, a data signal, a clock signal and a synchronization signal and outputting the data signal, the clock signal and the synchronization signal; and
a column driver for applying a pixel data voltage to the display panel in accordance with the data signal serially received from the timing controller,
wherein the timing controller transmits a setup information signal for setting up a registration and an operation of an element in the column driver during an initial setup mode before a normal driving mode in which a normal image is displayed after the power supply voltage is applied.

2. The display apparatus of claim 1 further comprising:
a data signal transmission line formed between the timing controller and the column driver to transmit the serialized data signal,
wherein the setup information signal is transmitted through the data signal transmission line.

3. The display apparatus of claim 2, wherein the setup information signal includes a first setup information signal transmitted in the initial setup mode and a second setup information signal transmitted in the normal driving mode.

4. The display apparatus of claim 3, wherein the setup information signal repeatedly transmit an identical setup information data more than two times, and wherein a transmission speed of the identical setup information data is lower than a transmission speed for displaying the image in the normal image display mode.

5. The display apparatus of claim 2, wherein the setup information signal includes at least one information selected from the group consisting of: information of the number of active pixels among total pixels in the display panel, delay information, inversion mode information, initial signal polarity information, scramble information, gate delay information, vertical blanking interval information, data polarity information and aging/refresh operation mode information.

6. A display apparatus comprising:
a display panel for displaying an image;
a timing controller for receiving a power supply voltage inputted from the outside, a data signal, a clock signal and a synchronization signal and outputting the data signal, the clock signal and the synchronization signal;
a column driver for receiving the data signal from the timing controller to apply an image signal to the display panel;
a data signal transmission line for transmitting the data signal between the timing controller and the column driver; and
a clock signal transmission line for transmitting the clock signal,
wherein the column driver measures a skew between the data signal and the clock signal during an initial setup mode before a normal driving mode in which a normal image is displayed after the power supply voltage is applied, generates a skew compensation value by using the measured skew, and compensates for the skew between the data signal and the clock signal by using the generated skew compensation value.

7. The display apparatus of claim 6, wherein the timing controller transmits a training pattern signal for measuring the skew, and the column driver measures the skew by using the training pattern signal, generates the skew compensation value corresponding to the skew, and compensates for the skew by applying the skew compensation value to the data signal or the clock signal.

8. The display apparatus of claim 7, wherein the skew is measured by comparing a phase of the training pattern signal with a phase of the clock signal, and wherein the skew compensation value is a value generated to correspond to the measured skew.

9. The display apparatus of claim 7, wherein the training pattern signal has a constant period, or the training pattern signal has the same pattern as a pattern of the clock signal.

10. (canceled)

11. The display apparatus of claim 6, wherein the skew compensation value is generated by using the skew which is further measured in a vertical blanking interval and a horizontal blanking interval of the normal driving mode, and wherein the skew compensation value is applied to the data signal or the clock signal to compensate for the skew.

12. The display apparatus of claim 6, wherein the skew is measured by using the data signal in a normal display interval of the normal driving mode, and wherein the skew is compensated for by applying the skew compensation value generated by the measured skew to the data signal or the clock signal of an initial skew compensation generated by using the initial setup mode.

13. The display apparatus of claim 6, further comprising a storage section for storing the skew compensation value.

14. The display apparatus of claim 13, wherein the storage section stores the skew compensation value as a binary data value, or the storage section stores the skew compensation value as a voltage.

15. (canceled)

16. A display apparatus comprising:
a display panel for displaying an image;
a timing controller for receiving a power supply voltage inputted from the outside, a data signal, a clock signal and a synchronization signal and outputting the data signal, the clock signal and the synchronization signal;
a column driver for receiving the data signal from the timing controller to apply an image signal to the display panel;
a data signal transmission line disposed between the timing controller and the column driver to transmit the data signal; and
a clock signal transmission line for transmitting the clock signal,
wherein the column driver generates a skew compensation value by using a signal inputted during a vertical blanking interval or a horizontal blanking interval in a normal driving mode in which a normal image is displayed after the power supply voltage is applied, and compensates for the skew by applying the skew compensation value to the data signal or the clock signal.

17. The display apparatus of claim 16, wherein the timing controller transmits a training pattern signal for calculating the skew, and the column driver measures the skew by using the training pattern signal, generates the skew compensation value corresponding to the skew, and applies the skew compensation value to the data signal or the clock signal.

18. The display apparatus of claim 17, wherein the skew is measured by comparing a phase of the training pattern signal with a phase of the clock signal, and wherein the skew compensation value is a value generated to correspond to the measured skew; or wherein the skew is measured by using the data signal in a normal display interval of the normal driving mode, and wherein the skew is compensated for by applying the skew compensation value generated by the measured skew to the data signal or the clock signal.

19. The display apparatus of claim 17, wherein the training pattern signal has a constant period, or the training pattern signal has the same pattern as a pattern of the clock signal.

20. (canceled)

21. (canceled)

22. The display apparatus of claim 16, further comprising: a storage section for storing the skew compensation value.

23. The display apparatus of claim 22, wherein the storage section stores the skew compensation value as a binary data value, the storage section stores the skew compensation value as a voltage.

24. (canceled)

25. The display apparatus of claim 1 comprising:
a display panel for displaying an image;
a timing controller for receiving a power supply voltage inputted from the outside, a data signal, a clock signal and a synchronization signal and outputting the data signal, the clock signal and the synchronization signal;
a column driver for applying a pixel data voltage to the display panel in accordance with the data signal serially received from the timing controller;
a data signal transmission line for transmitting the data signal between the timing controller and the column driver; and
a clock signal transmission line for transmitting the clock signal,
wherein the timing controller transmits a setup information signal for setting up a registration and an operation of an element in the column driver during an initial setup mode before a normal driving mode in which a normal image is displayed after the power supply voltage is applied, and
wherein the column driver receives the setup information signal, sets up the registration and the operation of the element of the column driver in the initial setup mode, measures a skew of between the data signal and the clock signal in the initial setup mode, generates a skew compensation value by using the measured skew, and compensates for the skew by using the generated skew compensation value.

26. The display apparatus of claim 1 comprising:
a display panel for displaying an image;
a timing controller for receiving a power supply voltage inputted from the outside, a data signal, a clock signal and a synchronization signal and outputting the data signal, the clock signal and the synchronization signal;
a column driver for applying a pixel data voltage to the display panel in accordance with the data signal serially received from the timing controller;
a data signal transmission line for transmitting the data signal between the timing controller and the column driver; and
a clock signal transmission line for transmitting the clock signal,
wherein the timing controller transmits a setup information signal for setting up a registration and an operation of an element in the column driver during an initial setup mode before a normal driving mode in which a normal image is displayed after the power supply voltage is applied, and
wherein the column driver receives the setup information signal, sets up the registration and the operation of the element of the column driver in the initial setup mode, measures a skew of between the data signal and the clock signal during a horizontal blanking interval or a vertical blanking interval, generates a skew compensation value by using the measured skew, and compensates for the skew by using the generated skew compensation value.

27. A timing controller for transmitting a data signal to a column driver in a display apparatus, the timing controller comprising:
a data format section for receiving a power supply voltage inputted from a host system, the data signal, a clock signal and a synchronization signal, and transmitting the data signal, the clock signal and the synchronization signal to the column driver; and
a protocol controller for transmitting a setup information signal for setting up an element and an operation of the column driver during an initial setup mode before a normal driving mode in which a normal image is displayed after the power supply voltage is applied.

28. The timing controller of claim 27, wherein the setup information signal is transmitted through a data signal transmission line for transmitting the data signal between the timing controller and the column driver.

29. The timing controller of claim 28, wherein the setup information signal includes a first setup information signal transmitted in the initial setup mode and a second setup information signal transmitted in the normal driving mode; or wherein the setup information signal includes at least one information selected from the group consisting of: information of the number of active pixels among total pixels in the display panel, delay information, inversion mode information, initial signal polarity information, scramble information, gate delay information, vertical blanking interval information, data polarity information and aging/refresh operation mode information.

30. The timing controller of claim 29, wherein the setup information signal repeatedly transmit an identical setup information data more than two times, and wherein a transmission speed of the identical setup information data is lower than a transmission speed for displaying the image in the normal image display mode.

31. The timing controller of claim 28, wherein a control signal for informing transmission of the setup information signal is transmitted while the setup information signal is transmitted.

32. (canceled)

33. The timing controller of claim 28, further comprising:
a setup information storage section for storing a setup information of the column driver; and
a setup information signal generating section for generating the setup information signal by using the setup information inputted from the setup information storage section.

34. A timing controller for transmitting a data signal to a column driver in a display apparatus, the timing controller comprising:
a data format section for receiving a power supply voltage inputted from a host system, the data signal, a clock signal and a synchronization signal, rearranging the data signal, and outputting the rearranged data signal; and
a training pattern generating section for generating a training pattern signal to compensate for a skew generated between the clock signal and the data signal applied to the column driver during an initial setup mode before a normal driving mode in which a normal image is displayed after the power supply voltage is applied,
wherein the training pattern signal is transmitted to the column driver through a data signal transmission line through which the data signal is transmitted.

35. The timing controller of claim 34, wherein the training pattern signal has a constant period, or the training pattern signal has the same pattern as a pattern of the clock signal, or the training pattern signal is transmitted in a horizontal blanking interval or a vertical blanking interval of the normal driving mode.

36. (canceled)

37. (canceled)

38. A timing controller for transmitting a data signal to a column driver in a display apparatus, the timing controller comprising:
a data format section for receiving a power supply voltage inputted from a host system, the data signal, a clock signal and a synchronization signal, rearranging the data signal, and outputting the rearranged data signal; and
a training pattern generating section for generating a training pattern signal to compensate for a skew generated between the clock signal and the data signal applied to the column driver in a horizontal blanking interval or a vertical blanking interval of a normal driving mode in which a normal image is displayed after the power supply voltage is applied.

39. The timing controller of claim 38, wherein the training pattern signal has a constant period, or the training pattern signal has the same pattern as a pattern of the clock signal.

40. (canceled)

41. The timing controller of claim 27 comprising:
a data format section for receiving a power supply voltage inputted from a host system, the data signal, a clock signal and a synchronization signal, and transmitting the data signal, the clock signal and the synchronization signal to the column driver;
a protocol controller for transmitting a setup information signal for setting up an element and an operation of the column driver during an initial setup mode before a normal driving mode in which a normal image is displayed after the power supply voltage is applied; and
a training pattern generating section for generating a training pattern signal to compensate for a skew generated between the clock signal and the data signal applied to the column driver in the initial setup mode.

42. The timing controller of claim 27 comprising:
a data format section for receiving a power supply voltage inputted from a host system, the data signal, a clock signal and a synchronization signal, and transmitting the data signal, the clock signal and the synchronization signal to the column driver;
a protocol controller for transmitting a setup information signal for setting up an element and an operation of the column driver during an initial setup mode before a normal driving mode in which a normal image is displayed after the power supply voltage is applied; and
a training pattern generating section for generating a training pattern signal in a vertical blanking interval or a horizontal blanking interval to compensate for a skew generated between the clock signal and the data signal applied to the column driver in the normal driving mode,
wherein the training pattern signal is transmitted to the column driver through a data signal transmission line through which the data signal is transmitted.

43. A column driver for providing a pixel data voltage to a display panel in accordance with a data signal transmitted from a timing controller, wherein the column driver receives a setup information signal from the timing controller in an initial setup mode before a normal driving mode in which a normal image is displayed after the power supply voltage is applied or in the normal driving mode, transmits the setup information signal to at least one selected from the group consisting of an embedded data sampler, a serial-parallel converting section, a shift register, a data latch and a digital/analog converting section, and sets up its element and operation.

44. The column driver of claim 43, wherein the setup information signal is transmitted from the timing controller through a data signal transmission line through which the data signal is transmitted; or wherein the setup information signal includes at least one information selected from the group consisting of: information of the number of active pixels among total pixels in the display panel, delay information, inversion mode information, initial signal polarity information, scramble information, gate delay information, vertical blanking interval information, data polarity information and aging/refresh operation mode information.

45. The column driver of claim 44, further comprising:
a column driver setup information signal register for storing the setup information signal,
wherein the setup information signal repeatedly transmit an identical setup information data more than two times, and
wherein a transmission speed of the identical setup information data is lower than a transmission speed for displaying the image in the normal image display mode.

46. The column driver of claim 44, wherein a transmission mode control signal is received while the setup information signal is received, and an output of the setup information signal is controlled in accordance with the received transmission mode control signal.

47. (canceled)

48. A column driver for providing a pixel data voltage to a display panel in accordance with a data signal transmitted from a timing controller, the column driver comprising:
a skew compensating section for measuring a skew between a training pattern signal and a clock signal received from the timing controller in a normal driving mode in which a normal image is displayed after a power supply voltage is applied or in an initial setup mode before the normal driving mode, and generate a skew compensation value corresponding to the measured skew,
wherein the skew compensation value is applied to the data signal or the clock signal to compensate for the skew.

49. The column driver of claim 48, wherein the skew compensating section measures the skew by comparing a phase of the training pattern signal with a phase of the clock signal.

50. The column driver of claim 48 or claim 49, further comprising: a storage section for storing the skew compensation value.

51. The column driver of claim 50, wherein the storage section stores the skew compensation value as a binary data value, or the storage section stores the skew compensation value as a voltage.

52. (canceled)

53. The column driver of claim 48 comprising:
a skew compensating section for measuring a skew between a training pattern signal and a clock signal received from the timing controller in a normal driving mode in which a normal image is displayed after a power supply voltage is applied or in an initial setup mode before the normal driving mode, and generate a skew compensation value corresponding to the measured skew,
wherein the skew compensation value is applied to the data signal or the clock signal to compensate for the skew, and
wherein a setup information signal is received from the timing controller, and is transmitted to at least one selected from the group consisting of an embedded data sampler, a serial-parallel converting section, a shift register, a data latch and a digital/analog converting section, whereby setting up its element and operation.
